(19) United States
(12) Patent Application Publication
(10) Pub. No.: US 2020/0134636 A1
(43) Pub. Date: Apr. 30, 2020

(54) DIGITAL WARRANTY MANAGEMENT SERVER AND PRODUCT MANAGEMENT METHOD

(71) Applicant: WARRANTEE INC., Osaka-shi, Osaka (JP)

(72) Inventor: Yusuke SHONO, Osaka-shi (JP)

(73) Assignee: Warrantee Inc., Osaka-shi, Osaka (JP)

(21) Appl. No.: 16/479,919

(22) PCT Filed: Dec. 12, 2017
(86) PCT No.: PCT/JP2017/044613

§ 371 Date: Sep. 12, 2019

(30) Foreign Application Priority Data
Jan. 24, 2017 (JP) 2017-010773

(51) Int. Cl. G06Q 30/00; G06Q 30/02

(52) U.S. Cl. CPC G06Q 30/012; G06Q 30/0283

(57) ABSTRACT

To digitally manage product warranty periods and to prompt a user to sell a used product. Provided is a management server 100 comprising: a product table 121 which, for each user, stores information relating to a product possessed the user and a warranty period for said product; and a secondhand trader table 124 which, for each secondhand trader, stores information relating to a product for which the secondhand trader is able to compute a purchase price. Information is extracted from the product table 121 which relates to a product that has reached the end of the warranty period or has reached a predetermined time before expiry of the warranty period or a predetermined time after same. The terminal 400 of a secondhand trader being able to compute a purchase price for the product is notified of information relating to the product that has been extracted from the product table 121. Information relating to the purchase price of the product having been computed by the secondhand trader is received from the terminal 400 of the secondhand trader. The terminal 200 of the user who possesses the product is notified of the information relating to the purchase price of the product.

### TECHNICAL FIELD

The present invention relates to a management server which manages a digitized warranty and a product management method that the management server executes. More specifically, the present invention can notify a user of a purchase price of a product of which a warranty term is approaching, and can cause the user to recognize the value of the product.

### BACKGROUND ART

In the related art, a system has been known which digitizes a warranty of an appliance or the like that a consumer owns, and notifies, when a warranty term is approaching, notify the consumer to that effect (Patent Literature 1). The system in Patent Literature 1 manages information relating to the warranty of the consumer collectively by using a service center, and periodically notifies a terminal of the consumer of period information until the expiration date of the warranty term so as to evoke free service for a product required to be repaired, and to introduce a new product after the warranty term is expired.

### CITATION LIST

### Patent Literature

Patent Literature 1: JP 2004-192214 A

### SUMMARY OF INVENTION

### Technical Problem

However, in recent years, it has become popular for consumers to sell their own products to used-product purchasers, or to trade products between consumers through the interne auction or the like, and the market size of the used-product distribution has been expanding year by year. Therefore, the number of consumers who are willing to actively sell their own products is also on the rise, and it can be said that there are a large number of consumers who want to positively consider sales if they have an opportunity of selling the product at an appropriate price, even if they are not active in selling their own products. If it is possible to evoke sale behavior of such consumers who potentially desire to sell their own products, it is expected that the market size of the used-product distribution further expands. On the other hand, the system in Patent Literature 1 is only to evoke a repair service within the warranty period of the product to the user and to introduce new products after the expiration of the warranty period, and has no function of urging the user to sell the used product.

Thus, an object of the present invention is to electronically manage a warranty term of a product and evoke sale behavior of a user for the used product before and after the warranty term.

### Solution to Problem

As a result of intensive investigations for the means for achieving the above-described object, the inventors of the present invention have found that it is possible to manage a warranty term of a product that each user owns by using a management server, and to motivate the user to sell the product by notifying the user of a purchase price of the used product before and after the warranty term. Thus, the inventors have conceived of achieving the above-described object based on the above-described findings and completed the present invention. Specifically, the present invention has the following configurations and steps.

A first aspect of the present invention relates to a management server. The management server according to the present invention includes a product table, a purchaser table, a warranty term management unit, an information notification unit, and an information reception unit. The product table and the purchaser table are stored in a storage unit (database). The product table stores information relating to a product owned by a user and a warranty term of the product for each user. The purchaser table stores information relating to a product of which a purchase price is calculable for each purchaser. The warranty term management unit extracts, from the product table, information relating to a product which has reached a warranty term, a predetermined period before the warranty term, or a predetermined period after the warranty term. The information notification unit refers to the purchaser table and notifies a terminal of a purchaser able to calculate a purchase price of the product, of the information relating to the product extracted from the product table by the warranty term management unit. The information reception unit receives information relating to the purchase price of the product calculated by the purchaser, from the terminal of the purchaser. The information notification unit notifies a terminal of a user who owns the product, of the information relating to the purchase price of the product received by the information reception unit. At this time, the information notification unit may notify the user of the warranty term of the product together with the purchase price of the product.

As in the above-described configuration, when a warranty term of a certain product is approaching or the warranty term is exceeded, the management server according to the present invention automatically requests the purchaser to calculate a purchase price of the product, and notifies a user who owns the product, of the purchase price of the product calculated by the purchaser. In this manner, the user who has received the notification can grasp the purchase price of the product while recalling the warranty term of the product. Therefore, if the user who has received the notification determines that the purchase price of the product is appropriate or higher than expected, the user becomes to actively consider selling the product. Thus, according to the present invention, it is possible to evoke sale behavior of a user for a used product. In addition, since it becomes possible to request the purchaser for the purchase price of the used product in accordance with the arrival of the warranty term, it is possible to accurately notify the user of the current price of the product.

In the management server according to the present invention, it is preferable that the information reception unit receive information relating to a purchase price before the warranty term and a purchase price after the warranty term of the product from the terminal of the purchaser. In this case, the information notification unit notifies the terminal of the user who owns the product, of the information relating to the purchase price before the warranty term and the purchase price after the warranty term of the product.

As in the above-described configuration, by notifying the user of the purchase price before the warranty term and the purchase price after the warranty term, it is possible to cause the user to consider whether to sell the product within the warranty period or to sell after the warranty period is expired in consideration of cost effectiveness. Selling the product within the warranty period increases the product purchase price in general, but it becomes easy to understand the merit of selling the product within the warranty period by presenting both the purchase prices before and after the warranty term to the user, and thus it is possible to urge the user to sell the product early. It can be expected that a used-product distribution market will become more active if relatively new products are available in the market.

It is preferable that the management server according to the present invention include a reverse auction processing unit. The reverse auction processing discloses first the information relating to the product and the purchase price of the product to receive a purchase application for the product. In addition, in a case where there is a purchase application for the product, the reverse auction processing unit notifies the terminal of the user who owns the product, of information relating to the purchase application, and inquires of the user whether to sell the product.

As in the above-described configuration, in a case where, after the user is notified of a purchase price of the product, there is a purchase application for the product at the purchase price, the fact that there is a purchase application at the purchase price is notified to the user. In this manner, it is possible to further evoke motivation of the user to sell the product. In addition, since the user can automatically receive a purchase application for a product without actively acting for selling the product, it is possible to give an opportunity of selling a product to a user who is potentially considering selling a product. In this manner, it can be expected that the number of products available in the used-product distribution market is increased.

It is preferable that the management server according to the present invention further include a manufacturer table. The manufacturer table stores information relating to a product for which a notification is desired to be received for each manufacturer. In this case, the information notification unit refers to the manufacturer table and notifies a terminal of a manufacturer who desires to receive a notification for the product, of the information relating to the product extracted from the product table.

As in the above-described configuration, within the warranty term of the product or before or after the warranty term of the product, the manufacturer is notified of the fact that the warranty term of the product is reached and the information of the user who owns the corresponding product. In this manner, the manufacturer can grasp users who may replace a product. Therefore, the manufacturer can efficiently provide a guide (advertisement or the like) for a new product to the user.

In a case where the user determines to sell the product with respect to the purchase application for the product in the above reverse auction processing, the management server according to the present invention notifies a terminal of a manufacturer who desires to receive a notification for the product, of information indicating that the user sold the product together with the information relating to the user who owns the product.

The fact that the user sold the product in the reverse auction processing is likely to cause the user to newly buy a replacement for the sold product. Therefore, by notifying the manufacturer of such information indicating that the reverse auction has been established, the manufacturer can provide a guide for a replacement of the product sold in the reverse auction, to the user. In this manner, it is possible to enhance advertising effectiveness of the manufacturer.

Another aspect of the management server according to the present invention will be described. A storage unit of the management server includes a product table and a purchase price table. As described above, the product table stores information relating to a product owned by a user and a warranty term of the product for each user. The purchase price table stores information relating to a purchase price is stored for each product. The warranty term management unit of the management server extracts, from the product table, information relating to a product which has reached a warranty term, a predetermined period before the warranty term, or a predetermined period after the warranty term, and extracts information relating to a purchase price of the product from the purchase price table. The information communication unit of the management server notifies a terminal of a user who owns the product, of the information relating to the product extracted from the product table and the information relating to the purchase price of the product extracted from the purchase price table.

As in the above-described configuration, the management server may include a purchase price table in which a purchase price of a product is stored. In this case, the purchase price of the product is acquired from the purchaser and is registered in the purchase price table, for example, whenever the warranty term of the product is reached, or the purchase price may be registered in advance in the purchase price table regardless of the calculation of the purchaser. Even in such a case, it is possible to evoke sale behavior of a user for the used product by notifying the user of the purchase price of the product at the arrival of the warranty term or before or after the warranty term.

A second aspect of the present invention relates to a product management method. In the product management method according to the present invention, the management server extracts, from a product table in which information relating to a product owned by a user and a warranty term of the product is stored for each user, information relating to a product which has reached a warranty term, a predetermined period before the warranty term, or a predetermined period after the warranty term. In addition, the management server refers to a purchaser table in which information relating to a product of which a purchase price is calculable is stored for each purchaser, and notifies a terminal of a purchaser able to calculate a purchase price of the product, of information relating to the product extracted from the product table. Next, the management server receives information relating to the purchase price of the product from the terminal of the purchaser. Next, the management server notifies a terminal of a user who owns the product, of the information relating to the purchase price of the product.

Another aspect of the product management method according to the present invention will be described. In the product management method according to the present invention, the management server extracts, from a product table in which information relating to a product owned by a user and a warranty term of the product is stored for each user, information relating to a product which has reached a warranty term, a predetermined period before the warranty term, or a predetermined period after the warranty term. In addition, the management server extracts, from a purchase price table in which information relating to a purchase price is stored for each product, information relating to a purchase price of the product which has reached the warranty term, the predetermined period before the warranty term, or the predetermined period after the warranty term. Next, the management server notifies a terminal of a user who owns the product, of the information relating to the product extracted from the product table and the information relating to the purchase price of the product extracted from the purchase price table.

### Advantageous Effects of Invention

According to the present invention, it is possible to electronically manage a warranty term of a product and evoke sale behavior of a user for the used product before and after the warranty term.

### BRIEF DESCRIPTION OF DRAWINGS

FIG. 1 is a schematic diagram illustrating a configuration example of the entire system.

FIG. 2 is a block diagram illustrating a functional configuration example of various devices included in the system.

FIG. 3 illustrates a data configuration example of various tables of a management server.

FIG. 4 is a flowchart illustrating an example of processing of the entire system.

FIG. 5 illustrates a relationship of business operators and users who participate in the system.

### DESCRIPTION OF EMBODIMENTS

Hereinafter, embodiments of the present invention will be described using the drawings. The present invention is not limited to the embodiments described below, and includes those appropriately modified by those skilled in the art from the following embodiments within the obvious scope.

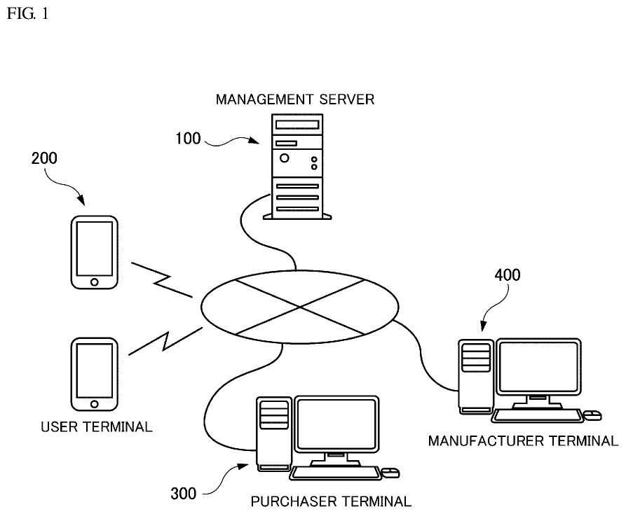

FIG. 1 illustrates a configuration example of the entire system including a management server 100, a user terminal 200, a purchaser terminal 300, and a manufacturer terminal 400. As illustrated in FIG. 1, the management server 100 and various terminals 200, 300, and 400 are connected to each other via a communication line such as the Internet. The management server 100 is a web server that is maintained and operated by a business operator who manages the present system. The management server 100 may be constituted of one server or may be constituted of a plurality of servers connected via the Internet. The user terminal 200 is a terminal that is owned by a user of the present system, that is, an owner of the product. The user can receive a notification of a warranty term of a product via the user terminal 200 or perform a procedure of selling the product in a reverse auction or a procedure of buying a new product. The purchaser terminal 300 is a terminal that is owned by a purchaser of a used product. The purchaser can provide a purchase price of a used product to the management server 100 via the purchaser terminal 300 or apply for a purchase of a used product. The manufacturer terminal 400 is a terminal that is owned by a manufacturer who sells a new product. The manufacturer can provide a guide for a new product to the user via the manufacturer terminal 400 or sell a new product to the user. Examples of the various terminals 200, 300, and 400 are a mobile information terminal such as a smartphone, a tablet computer, and a tablet terminal and a stationary information terminal such as a desktop computer. As each of the various terminals 200, 300, and 400, a plurality of terminals are present in general.

The management server 100 can manage a warranty term of various products. Examples of the product are appliances, furniture, fittings, household goods, cars and bicycles. However, the examples of the product are not limited thereto, and various products having a warranty term can be managed by the management server 100.

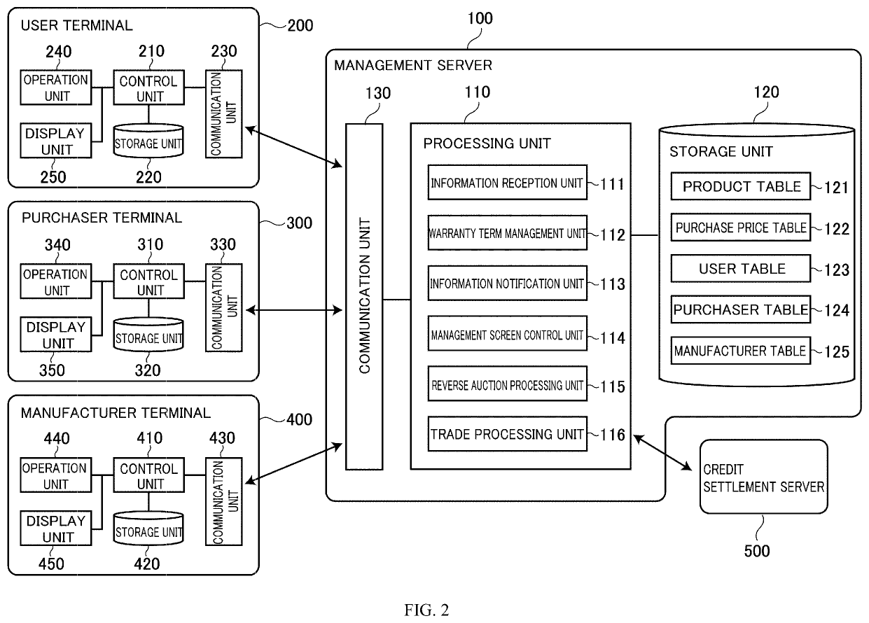

FIG. 2 is a block diagram illustrating a functional configuration of the management server 100 and the various terminals 200, 300, and 400. The management server 100 includes a processing unit 110, a storage unit 120, and a communication unit 130. As the processing unit 110, a processor such as a CPU or a GPU can be utilized. The processing unit 110 reads a server program stored in the storage unit 120 and controls other elements according to the program, thereby executing operation processing of the entire system. The storage unit 120 functions as a database in which various information required for operating the system is stored. The storage function of the storage unit 120 can be implemented by a nonvolatile memory such as HDD or SDD. In addition, the storage unit 120 may have a function as a memory for writing or reading progress of arithmetic processing or the like by the processing unit 110. The memory function of the storage unit 120 can be implemented by a volatile memory such as RAM or DRAM. The communication unit 130 has a function of communicating with the various terminals 200, 300, and 400 via a communication line such as the Internet. The communication standard may be in accordance with a well-known standardized standard, and is not particularly limited.

Basically, the various terminals 200, 300, and 400 include, respectively, control units 210, 310, and 410, storage units 220, 320, and 420, communication units 230, 330, and 430, operation units 240, 340, and 440, and display units 250, 350, and 450. The control units of the various terminals can be implemented by a processor such as a PU or a GPU. The storage units of the various terminals can be implemented by a nonvolatile memory such as HDD or SDD or a volatile memory such as RAM or DRAM. The communication units of the various terminals have a function of communicating with the management server 100 via a communication line such as the Internet. The operation units of the various terminals are composed of input devices such as a mouse, a keyboard, a touch panel, and a microphone and receive operation information by a person. The display units of the various terminals are display devices such as a liquid crystal display or an organic EL display. The display unit may configure a touch panel display integrated with the operation unit.

The storage units of the various terminals store an application program dedicated to the present system and a general-purpose web browser program. When these programs are activated, the various terminals can access the management server 100 via the dedicated application or the web browser, and can receive information provided from the management server 100 or transmit information to the management server 100. The information received from the management server 100 is displayed on the display units of the various terminals. When a user or the like inputs required information via the operation units of the various terminals, the information is transmitted to the management server 100 via the communication units. In this manner, the management server 100 performs exchange of information between the various terminals.

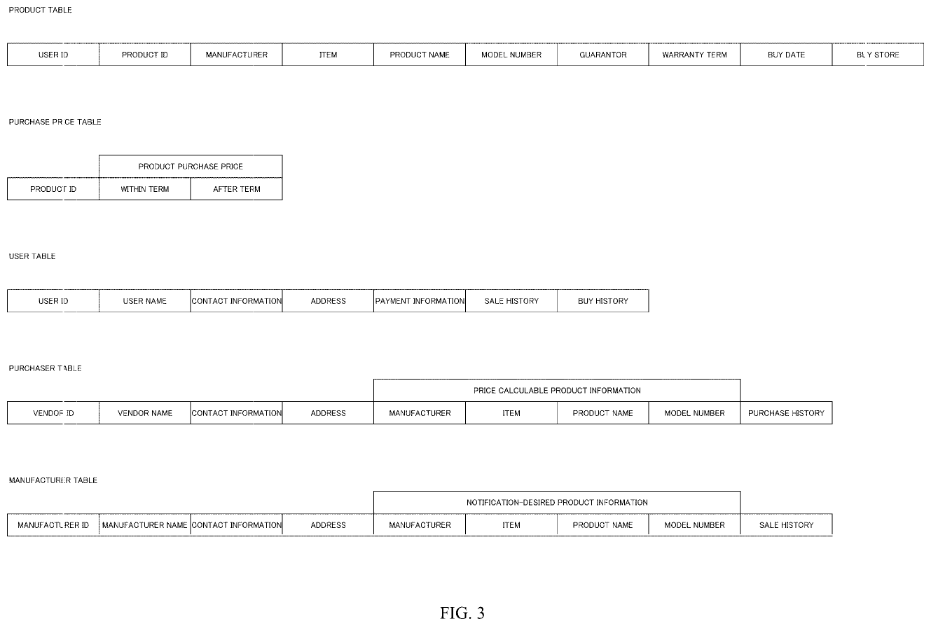

Subsequently, the functional configuration of the management server 100 will be described in detail. As illustrated in FIG. 2, the storage unit 120 of the management server 100 stores a product table 121, a purchase price table 122, a user table 123, a purchaser table 124, and a manufacturer table 125. A data configuration example of various tables is illustrated in FIG. 3.

The product table 121 stores, for each user, information relating to a product that the user owns, and a warranty term of the product. The product table 121 has, for example, a user ID field in which identification information specific to a user is registered; a product ID field in which identification information specific to a product that a user owns is registered; a manufacturer field in which information (ID or name) of a manufacturer who manufactured the product is registered; an item field in which an item of the product is registered; a product name filed in which the name of the product is registered; a model number field in which a model number or a model year of the product is registered; a guarantor field in which information (ID or name) of a guarantor (manufacturer or seller) who guarantees the product is registered; a warranty term field in which a warranty term of the product is registered; a buy date field in which a date when the product is bought is registered; and a buy store field in which information of a store where the user bought the product is registered. A key item is the user ID field. Basically, information which is input by a user via the user terminal 200 is registered in the product table 121. Note that, in the product table 121, in addition to the information described above, information collected by the management server 100 through the internet search can be registered, or information acquired from the manufacturer terminal 400 by the management server 100 inquiring of the manufacturer terminal 400 can be registered.

The purchase price table 122 stores information relating to a purchase price for each product. The purchase price table 122 has, for example, a product ID field in which identification information specific to a product is registered; and a product purchase price field in which a purchase price of the product is registered. A key item is the product ID field. As illustrated in FIG. 3, the product purchase price field may be divided into a field in which a purchase price within the warranty term is registered and a field in which a purchase price after the warranty term is registered. In a case where the product purchase price has not been registered, as described below, the management server 100 inquires of the purchaser terminal 300 about the calculation of the product purchase price, and registers the price received from the purchaser terminal 300 in the purchase price table 122. In a case where the product purchase price has been already registered, the management server 100 does not necessarily inquire of the purchaser terminal 300. Note that, since the purchase price of the product changes over time, even in a case where the product purchase price has been already registered, it is preferable that the management server 100 periodically inquire of the purchaser terminal 300. In this case, the information registered in the product purchase price field is updated to a product purchase price newly acquired from the purchaser terminal 300.

The user table 123 stores, for each user, information relating to the user. The user table 123 has, for example, a user ID field in which identification information specific to the user is registered; a user name field in which the name of the user is registered; a contact information field in which contact information (email address or phone number) of the user is registered; an address field in which an address of the user is registered; a payment information field in which payment information (information relating to a credit card) of the user is registered; a sale history field in which information relating to a history of products sold by the user through the reverse auction processing of the present system is stored; and a buy history field in which information relating to a history of products bought by the user through trade processing of the present system is stored. A key item is the user ID field.

The purchaser table 124 stores, for each purchaser, information relating to a product of which the purchase price can be calculated. The purchaser table 124 has, for example, a vendor ID field in which identification information specific to a purchaser is registered; a vendor name field in which the name of the purchaser is registered; a contact information field in which contact information (email address or phone number) of the purchaser is registered; an address field in which an address of the purchaser is registered; a purchase price calculable product information in which information relating to a product of which the price can be calculated by the purchaser is registered; and a purchase history field in which a history of products that the purchaser purchased from the user is registered. A key item is the vendor ID field. In addition, as illustrated in FIG. 3, the purchase price calculable product information field may be divided into a field in which information relating to a manufacturer who manufactured the product is registered; a field in which an item of the product is registered; a field in which the name of the product is registered; and a field in which a model number or a model year of the product is registered.

The manufacturer table 125 stores, for each manufacturer, information relating to a product for which a notification is desired to be received. The manufacturer table 125 has, for example, a manufacturer ID field in which identification information specific to a manufacturer is registered; a manufacturer name field in which the name of the manufacturer is registered; a contact information field in which contact information (email address or phone number) of the manufacturer is registered; an address field in which an address of the manufacturer is registered; a notification-desired product information field in which information relating to a product for which a notification is desired to be received is registered; and a sale history field in which information relating to a history of products sold by the manufacturer through sale processing of the present system is stored. A key item is the manufacturer ID field. In addition, as illustrated in FIG. 3, the notification-desired product information field may be divided into a field in which information relating to a manufacturer who manufactured the product is registered; a field in which an item of the product is registered; a field in which the name of the product is registered; and a field in which a model number and/or a model year of the product is registered.

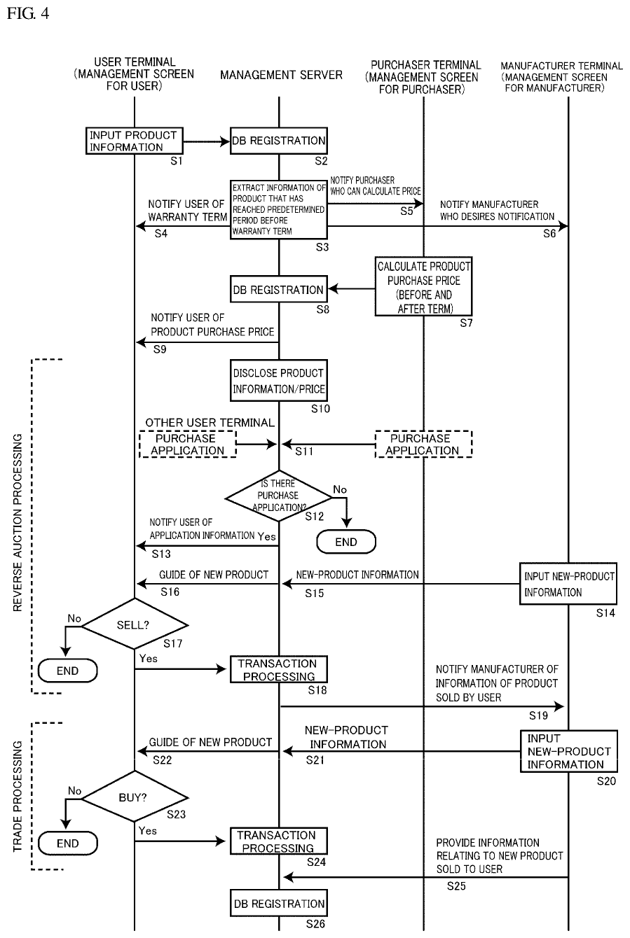

The processing unit 110 of the management server 100 can perform processing of notifying the user of a warranty term, reverse auction processing of giving the user an opportunity of selling a product, and trade processing of giving the user an opportunity of buying a new product while registering information to the respective tables 121 to 125 of the storage unit 120, or referring to or updating the information registered in the respective tables 121 to 125. Specifically, as illustrated in FIG. 2, the processing unit 110 includes an information reception unit 111, a warranty term management unit 112, an information notification unit 113, a management screen control unit 114, a reverse auction processing unit 115, and a sale processing unit 116. Hereinafter, the respective functional configurations 111 to 116 of the processing unit 110 will be described in detail with reference to the flowchart of the present system illustrated in FIG. 4.

As illustrated in FIG. 4, in the present system, first, each user inputs information relating to his/her own products, to the user terminal 200 (step S1). Here, the product information input to the user terminal 200 includes information for the registration in each field of the product table 121 described above. It is preferable that at least product information including the warranty term of a product that the user owns be input to the user terminal 200 in addition to the name or model number of the corresponding product. A method of inputting the product information is not particularly limited. For example, the user may input characters or numbers to the user terminal 200; a receipt or a barcode of a product may be imaged by a camera of the user terminal 200 so that product information is automatically analyzed in the user terminal 200; and product information may be automatically acquired from the website of each manufacturer through the internet search in the user terminal 200 after the user inputs a model number or the like of the product to the user terminal 200. In addition, in a case where the user terminal 200 activates the application program dedicated to the present system, a management screen (user interface) for inputting product information by the dedicated application is provided. In addition, in a case where the user terminal 200 activates the general-purpose web browser program, the management screen control unit 114 of the management server 100 can provide a management screen for inputting product information to the user terminal 200 via the web browser. The user terminal 200 transmits the product information that is input in this manner, to the management server 100 together with the user ID specific to the user.

The information reception unit 111 of the management server 100 receives the product information and the user ID from the user terminal 200, and registers the product information of each user in the product table 121 (step S2). In addition, the information reception unit 111 may have a function of receiving only part of the product information that should be registered in the product table 121 from the user terminal 200 and automatically collecting other required information from other websites. In this case, it is sufficient that, for example, only the model number and the warranty term of the product are transmitted from the user terminal 200 to the management server 100, and thus it is possible to save time and effort of the user.

The warranty term management unit 112 of the management server 100 monitors the warranty term of each product registered in the product table 121. Then, the warranty term management unit 112 extracts information of a product which has reached a predetermined period before the warranty term, from the product table 121 (step S3). For example, the warranty term management unit 112 may extract a product which has exceeded a predetermined ratio (for example, 1/2 or 2/3) of the entire warranty period, or may extract a product which has reached predetermined days before the warranty period (for example, before six months or one year). Further, as another aspect, the warranty term management unit 112 can extract a product which has reached the expiration date of the warranty term or can extract a product for which a predetermined period has passed from the warranty term.

Next, the information notification unit 113 of the management server 100 notifies the user, who owns a product that has reached a predetermined period before a warranty term, of information of the product and the warranty term of the product (step S4), and thereby each user can know that the warranty term of his/her own product is approaching. For example, the management screen control unit 114 of the management server 100 provides a management screen for a user to the user terminal 200 of each user. Therefore, it is sufficient that the information notification unit 113 notifies the user terminal 200, which has accessed the management server 100 by using the web browser, of the product information and the warranty term of the product via the management screen for a user. In addition, the information notification unit 113 may notify an application dedicated to the user terminal 200 of the warranty term and the product information.

In addition, when a warranty term of a certain product is approaching, the information notification unit 113 of the management server 100 extracts a purchaser, who can calculate a purchase price of the corresponding product, by referring to the purchaser table 124, and notifies the purchaser terminal 300 of the extracted purchaser of product information and the warranty term of the product (step S5). This notification corresponds to a request for purchase price calculation from the management server 100 to the purchaser terminal 300. In addition, at this time, information relating to the user who owns the corresponding product may be extracted from the user table 123 and be notified to the purchaser terminal 300 from the management server 100. The management screen control unit 114 provides a management screen for a purchaser to each purchaser. Therefore, it is sufficient that the information notification unit 113 gives a notification of the warranty term and the product information via the management screen for a purchaser.

In addition, when a warranty term of a certain product is approaching, the information notification unit 113 of the management server 100 extracts a manufacturer, who desires to receive a notification of the corresponding product, by referring to the manufacturer table 125, and notifies the manufacturer terminal 400 of the extracted manufacturer of product information and the warranty term of the product (step S6). In addition, at this time, information relating to the user who owns the corresponding product is extracted from the user table 123 and is notified to the manufacturer terminal 400 from the management server 100. This notification is intended to inform the manufacturer that a replacement timing of the user's product is approaching. The management screen control unit 114 provides a management screen for a manufacturer to each manufacturer. Therefore, it is sufficient that the information notification unit 113 gives a notification of the product information, the warranty term, and the information of the user via the management screen for a manufacturer.

Next, the purchaser calculates the purchase price of the product which is requested from the management server 100, and inputs the calculated purchase price to the management screen or the like displayed on the purchaser terminal 300 (step S7). In particular, it is preferable that the management screen control unit 114 of the management server 100 provide, to the purchaser terminal 300, the management screen where the purchase price of the product before the warranty term and the purchase price of the product after the warranty term are input. In this case, the purchaser inputs the purchase price before and after the warranty term to the management screen. Then, the purchaser terminal 300 notifies the management server 100 of the purchase price of the product.

The information reception unit 111 of the management server 100 registers information relating to the purchase price of the product, which is received from the purchaser terminal 300, to the purchase price table 122 (step S8). In particular, in a case where both the purchase price before the warranty term and the purchase price after the warranty term are acquired, the information reception unit 111 registers both the purchase price before the warranty term and the purchase price after the warranty term in the purchase price table 122. Further, in a case where the purchase price is already registered for the same product, the information reception unit 111 updates the purchase price to new information.

Next, the management server 100 notifies the user, who owns a product of which the warranty term is approaching, of information relating to the purchase price of the corresponding product by referring to the purchase price table 122 (step S9). In this manner, the user can grasp the current value of his/her own product. In particular, by notifying the user of both the purchase price before the warranty term and the purchase price after the warranty term, it is possible for the user to grasp whether how much the purchase price changes when the warranty term is exceeded. For example, if a decline of the purchase price is large, the user may determine to sell the product before the warranty term. On the other hand, if a decline of the purchase price is small, the user may determine to continue using the product beyond the warranty term. In this manner, it is possible to give the user an opportunity of considering the necessity of selling the product, and the sale timing thereof.

Subsequently, reverse auction processing executed by the reverse auction processing unit 115 of the management server 100 will be described. In a normal auction, a seller side (user) first applies for a sale of a product, but in the reverse auction of the present system, a first purchaser side (other users or purchasers) submits a purchase application to the owner (user) of the product, and the owner determines whether to sell the product according to the purchase application.

As illustrated in FIG. 4, the reverse auction processing unit 115 extracts product information extracted from the product table 121, also extracts the purchase price of the corresponding product from the price purchase table 122, and discloses the product information and the purchase price (step S10). At this time, information disclosure, for example, may be made public only to members of the present system or may be made public to those including non-members. The scope of information disclosure may follow the intention of the user who owns the product. In addition, it is preferable that the information disclosure be limited to information relating to the product and its purchase price, and personal information of the user who owns the product be kept private. The reverse auction processing unit 115 may post the information on, for example, a website or the like dedicated to the present system.

The reverse auction processing unit 115 waits for a purchase application for a product from another user or a purchaser after the information is disclosed (step S11). The other user can submit a purchase application for a product by accessing the management server 100 via his/her own user terminal 200. In addition, the purchaser can submit a purchase application for a product by accessing the management server 100 via the purchaser terminal 300. Further, for example, the purchase price disclosed in step S10 may be set as a minimum price for submitting a purchase application for a product. In addition, the other user or the purchaser can arbitrarily set a bid price when submitting a purchase application.

Thereafter, the reverse auction processing unit 115 determines whether there is a purchase application for a product (step S12). The reception of the purchase application may be closed, for example, at the warranty term of each product, or may be closed after a predetermined period has elapsed from the warranty term. In addition, the reception of the purchase application may be continued until a period when the user desires to stop disclosure. The disclosure of the product information and the reception of the purchase application can be appropriately adjusted according to the desire of the user. Here, the reverse auction processing unit 115 ends the reverse auction processing if there is no purchase application at the time when the reception of the purchase application is closed. Further, after the reverse auction processing is ended, the processing may proceed to processing (trade processing) after step S20.

Subsequently, in a case where there is a purchase application from another user or a purchaser, the reverse auction processing unit 115 notifies the user, who owns the product, of the fact that there is a purchase application (step S13). For example, the name of the other user or the name of the purchaser, who has submitted a purchase application, and the bid price thereof are notified to the owner of the product. In addition, the reverse auction processing unit 115 may notify the owner of the product of the highest bid price and the name of the user or the name of the purchaser who has presented the highest bid price, among bid prices at which the applications are submitted by the deadline. The bid information is displayed on the management screen for a user or the screen of a dedicated application in the user terminal 200.

Here, the management server 100 may notify the user, who owns the product which is a target of the reverse auction, of a guide for a new product as an alternative to the corresponding product, after or simultaneously with the notification of the bid information. Specifically, a manufacturer who has received a notification indicating that a warranty term of a product owned by a certain user is approaching in step S6 inputs, the manufacturer terminal 400, information relating to a new product that the manufacturer wants to introduce to the user (step S14). The new-product information presented from the manufacturer to the user may be image information such as a leaflet or a pamphlet, or may be a URL or the like of a website on which an advertisement or a description of the new product is posted. The manufacturer terminal 400 notifies the management server 100 of such new-product information (step S15), and the management server 100 which has received the notification notifies the user of the new-product information (step S16). At this time, the user can acquire information relating to the new product from the manufacturer in addition to the purchase application and the bid price thereof from another user or the like for his/her own product. Therefore, the user can consider buying a new product with funds from selling his/her own product. In this manner, it is possible to simultaneously suggest selling a used product and buying a new product to the user.

Subsequently, the user considers whether to sell his/her own product and inputs a consideration result to the user terminal 200 (step S17). In a case where the user inputs that the user does not sell his/her own product, to the user terminal 200, or in a case where there is no input to the user terminal 200 within a certain period, it is considered that there is no intention to sell the product, and the reverse auction processing is ended.

On the other hand, in a case where the fact indicative of selling a product is input to the user terminal 200, the reverse auction processing unit 115 performs transaction processing between the user who owns the corresponding product and the other user or the purchaser who has submitted the purchase application for the corresponding product (step S18). The transaction processing includes general payment, product delivery, and processing. For example, the reverse auction processing unit 115 communicates with a credit settlement server 500 on the basis of credit card information of the purchase applier to receive purchase amount of the product, and transfers the purchase amount to an account of the owner of the product. In addition, a payment procedure may be account transfer, cash on delivery, or the like. In addition, the reverse auction processing unit 115 notifies the owner of the product, of the address of the purchase applier, and causes the owner to ship the product to the purchase applier. In this manner, the exchange between the owner of the product and the applier after the reverse auction processing is facilitated.

Subsequently, the trade processing executed by the trade processing unit 116 of the management server 100 will be described. The information notification unit 113 of the user terminal 200 notifies the manufacturer terminal 400 of the manufacturer who desires a notification, of information relating to a user who sold a product by establishment of the reverse auction, and the product information thereof (step S19). The manufacturer who has received such a notification inputs information relating to a new product that the manufacturer wants to introduce to the user, to the manufacturer terminal 400 (step S20). The new-product information presented from the manufacturer to the user may be image information such as a leaflet or a pamphlet, or may be a URL or the like of a website on which an advertisement or a description of the new product is posted. The manufacturer terminal 400 notifies the management server 100 of such new-product information (step S21), and the management server 100 that has received the new-product information notifies the user of the new-product information (step S22). At this time, since the user has just sold the product, there is a high possibility of buying a new product as an alternative to the product. Thus, advertisement effects can be enhanced by providing an advertisement of a new product to the user at this timing. Both the guide processing of a new product in steps S14 to S16 and the guide processing of a new product in steps S20 to S22 may be performed or either one thereof may be omitted.

Thereafter, the trade processing unit 116 of the management server 100 inquires of the user whether to buy a new product which is guided in step S16 or step S22 (step S23). In a case where the user inputs that the user does not buy a new product, to the user terminal 200, the trade processing unit 116 ends the trade processing of a new product. On the other hand, in a case where the fact indicative of buying a new product is input to the user terminal 200, the trade processing unit 116 performs transaction processing between the manufacturer who sells the corresponding new product and the user who buys the product (step S24). The transaction processing includes general payment, product delivery, and processing. For example, the trade processing unit 116 communicates with the credit settlement server 500 on the basis of credit card information of the user to receive buy amount of the new product, and transfers the buy amount to an account of the manufacturer who sells the new product. In addition, a payment procedure may be account transfer, cash on delivery, or the like. In addition, the trade processing unit 116 notifies the manufacturer who sells the new product, of the address of the user, and causes the manufacturer to ship the new product to the user. In this manner, the exchange between the manufacturer and the user after the trade processing is facilitated.

Subsequently, the manufacturer provides information relating to the new product sold to the user, to the management server 100 via the manufacturer terminal 400 (step S25). Here, the new-product information provided from the manufacturer terminal 400 to the management server 100 includes information to be registered in the product table 121, for example, information relating to a manufacturer name, an item, a product name, a model number and a model year, a guarantor name, a warranty term, a buy date, and a buy store. The management server 100 registers the information provided from the manufacturer terminal 400 in the product table 121 in association with the user who bought the product. In this manner, the user who bought the new product through the present system does not need to input information and the warranty term of the new product bought by himself/herself to the user terminal 200, and the warranty term of the new product is automatically managed in the management server 100. Therefore, when the warranty term for the new product bought by the user is approaching, it is possible to give a notification of the expiration date of the warranty term and the product purchase price thereof.

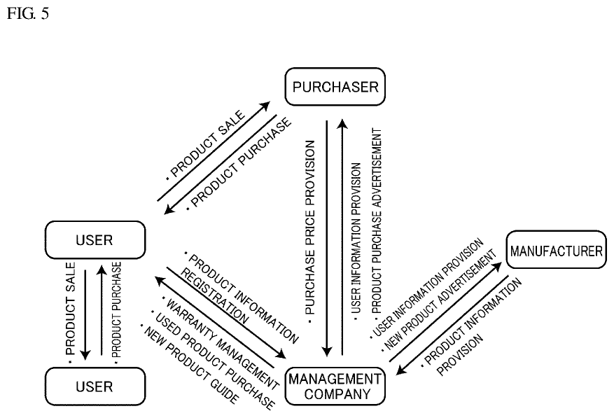

FIG. 5 illustrates a correlation between a management company operating the present system, and a user, a purchaser, and a manufacturer who participate in the present system. As illustrated in FIG. 5, the management company manages a warranty period of a product, provides an opportunity of selling a used product, or provides a guide for a new product, in return for receiving registration of product information from a user. In addition, the management company provides information of a user of the present system, and increases an opportunity for a purchaser to purchase a product from a user by evoking behavior of selling the used product of the user, in return for receiving provision of a purchase price from a purchaser. In addition, the management company provides information of a user of the present system, and provides an opportunity of selling a new product to a user, in return for receiving provision of the product information from the manufacturer. In addition, the users can trade used products with each other. In this manner, the participants in the present system can benefit from each other.

Hitherto, in the specification of the present application, the embodiments of the present invention have been described with reference to the drawings for describing the contents of the present invention. However, the present invention is not limited to the above-described embodiments, and includes modifications and improvements apparent to those skilled in the art based on the matters described in the specification of the present application.

### REFERENCE SIGNS LIST

100 management server

110 processing unit

111 information reception unit

112 warranty term management unit

113 information notification unit

114 management screen control unit

115 reverse auction processing unit

116 trade processing unit

120 storage unit

121 product table

122 purchase price table

123 user table

124 purchaser table

125 manufacturer table

130 communication unit

200 user terminal

210 control unit

220 storage unit

230 communication unit

240 operation unit

250 display unit

300 manufacturer terminal

310 control unit

320 storage unit

330 communication unit

340 operation unit

350 display unit

400 purchaser terminal

410 control unit

420 storage unit

430 communication unit

440 operation unit

450 display unit

1. A management server comprising:
a product table in which information relating to a product owned by a user and a warranty term of the product is stored for each user; and
a purchaser table in which information relating to a product of which a purchase price is calculable is stored for each purchaser,
wherein the management server
extracts, from the product table, information relating to a product which has reached a warranty term, a predetermined period before the warranty term, or a predetermined period after the warranty term,
notifies a terminal of a purchaser able to calculate a purchase price of the product, of the information relating to the product extracted from the product table,
receives information relating to the purchase price of the product calculated by the purchaser, from the terminal of the purchaser, and
notifies a terminal of a user who owns the product, of the information relating to the purchase price of the product.

2. The management server according to claim 1,
wherein the management server
receives information relating to a purchase price before the warranty term and a purchase price after the warranty term of the product from the terminal of the purchaser, and
notifies the terminal of the user who owns the product, of the information relating to the purchase price before the warranty term and the purchase price after the warranty term of the product.

3. The management server according to claim 1,
wherein the management server
discloses the information relating to the product and the purchase price of the product to receive a purchase application for the product, and
notifies the terminal of the user who owns the product, of information relating to the purchase application, and inquires of the user whether to sell the product, in a case where there is a purchase application for the product.

4. The management server according to claim 1, further comprising:
a manufacturer table in which information relating to a product for which a notification is desired to be received is stored for each manufacturer,
wherein the management server notifies a terminal of a manufacturer who desires to receive a notification for the product, of the information relating to the product extracted from the product table together with the information relating to the user who owns the product.

5. The management server according to claim 2, further comprising:
a manufacturer table in which information relating to a product for which a notification is desired to be received is stored for each manufacturer,
wherein in a case where the user determines to sell the product for the purchase application of the product, the management server notifies a terminal of a manufacturer who desires to receive a notification for the product, of information indicating that the user sold the product together with the information relating to the user who owns the product.

6. A management server comprising:
a product table in which information relating to a product owned by a user and a warranty term of the product is stored for each user; and
a purchase price table in which information relating to a purchase price is stored for each product,
wherein the management server
extracts, from the product table, information relating to a product which has reached a warranty term, a predetermined period before the warranty term, or a predetermined period after the warranty term, and extracts information relating to a purchase price of the product from the purchase price table, and
notifies a terminal of a user who owns the product, of the information relating to the product extracted from the product table and the information relating to the purchase price of the product extracted from the purchase price table.

7. A product management method comprising:
a step of extracting, from a product table in which information relating to a product owned by a user and a warranty term of the product is stored for each user, information relating to a product which has reached a warranty term, a predetermined period before the warranty term, or a predetermined period after the warranty term, by a management server;
a step of referring to a purchaser table in which information relating to a product of which a purchase price is calculable is stored for each purchaser, and notifying a terminal of a purchaser able to calculate a purchase price of the product, of the information relating to the product extracted from the product table, by the management server;
a step of receiving information relating to the purchase price of the product from the terminal of the purchaser, by the management server; and
a step of notifying a terminal of a user who owns the product, of the information relating to the purchase price of the product, by the management server.

8. A product management method comprising:
a step of extracting, from a product table in which information relating to a product owned by a user and a warranty term of the product is stored for each user, information relating to a product which has reached a warranty term, a predetermined period before the warranty term, or a predetermined period after the warranty term, by a management server;
a step of extracting, from a purchase price table in which information relating to a purchase price is stored for each product, information relating to a purchase price of the product which has reached the warranty term, the predetermined period before the warranty term, or the predetermined period after the warranty term, by the management server; and
a step of notifying a terminal of a user who owns the product, of the information relating to the product extracted from the product table and the information relating to the purchase price of the product extracted from the purchase price table, by the management server.
